(19) United States
(12) Patent Application Publication
(10) Pub. No.: US 2008/0264518 A1
(43) Pub. Date: Oct. 30, 2008

(54) Drink Dispensing System

(76) Inventor: Tess Collins, New South Wales (AU)

Correspondence Address: BOWDITCH & DEWEY, LLP, 311 MAIN STREET, P.O. BOX 15156, WORCESTER, MA, 01615-0156, US

(21) Appl. No.: 11/994,196

(22) PCT Filed: Jun. 28, 2006
(86) PCT No.: PCT/AU06/00911

§ 371 Date: Dec. 28, 2007

(30) Foreign Application Priority Data
Jun. 28, 2005 (AU) 2005903410

(51) Int. Cl. B67D 3/02

(52) U.S. Cl. 141/361

(57) ABSTRACT

A refillable drink container system is provided which comprises a drink dispensing unit with a filling tap located within a cavity and a refillable drink container having an opening for the passage of liquid therethrough, at least a portion of the container is adapted to enter the cavity and engage with the dispensing unit such that the opening in the container is positioned near the filling tap to allow liquid to be dispensed from the filling tap into the drink container and the engagement between the dispensing unit and the container prevents contact between the opening of the container and the filling tap.

### TECHNICAL FIELD

The present invention relates to a drink dispensing system comprising a refill tank and a reusable individual container to be filled from the tank and carried on a person.

### BACKGROUND

Drink dispensing systems are well known. One traditional system for providing drinking water in offices, factories and homes includes a cabinet like water dispenser for holding in an inverted position a large plastic bottle. The cabinet further comprises a filling tap that is manually depressed by the user's hand in order to fill the container below the tap with water. As the filling tap is exposed, the user may contact the nozzle portion and thus introduce contaminants into the water supply of those user's who subsequently use the dispensing system. In such drink dispensing systems it is difficult to safeguard the handling of the filling tap so as to protect the drinking water from contamination. This creates a potential health hazard.

In addition, in venues that serve large amounts of beverages such as clubs, bars, pubs, concert arenas, outdoor festivals, sporting arenas and the like there is the problem of a ‘build up’ of empty drinking vessels such as bottles, containers, glasses and the like throughout the venue during the course of an event. Traditionally, each time a drink is served, a new container is used to provide the drink to the customer. Therefore, the venue must have an excess supply of drinking containers and employ extra staff to collect the empty drink containers from around the venue. This traditional system of providing drinks in these sorts of venues causes the problem outlined above of the ‘build up’ of empty containers and the extra cost of supplying an excess of drinking containers and employing extra staff to collect the empty containers. This system also has detrimental effects to the environment, as often the containers in which the drink is served to the customer is a ‘use once and throw away’ bottle or the like.

In these venues, particularly where the cost of bottled water is high, it is common for people to purchase a drink in a container and once consumed, refill the container with water from a tap in the public amenities. In this case, the water is often not chilled, there are significant queues to get access to the taps in the public amenities and refilling the container from the taps in the public amenities is not very hygienic.

It is therefore an object of the present invention to provide a drink dispensing system which goes at least some way towards overcoming or at least minimizing the prior art problems or limitations outlined above.

### SUMMARY OF THE INVENTION

According to one aspect of the present invention there is provided a refillable drink container system comprising a liquid dispensing unit with a filling tap located within a cavity; and a refillable drink container having an opening for the passage of liquid therethrough, at least a portion of the container being adapted to enter the cavity and engage with the dispensing unit such that the opening in the container is positioned near the filling tap to allow liquid to be dispensed from the filling tap into the drink container, wherein the engagement between the dispensing unit and the container prevents contact between the opening of the container and the filling tap.

Preferably, in a first embodiment, the dispensing unit comprises a protrusion adapted to abut against an abutment surface of the container when the container is inserted into the cavity.

Preferably, the engagement between the dispensing unit and the container is, at least partially, provided by respective male and female members associated with the dispensing unit and the container.

Preferably, the male member is located on the dispensing unit and the female member is located on the container.

Preferably, the dispensing unit comprises at least one spigot; and an external surface of the container comprises at least one dimple adapted to engage the dispensing unit by receiving a portion of the at least one spigot therein; and the dimple provides an abutment surface for the spigot to prevent further insertion of the container into the cavity, thereby one of the at least one spigots prevents contact between the opening of the container and the filling tap.

Preferably, the at least one spigot comprises a spring member arranged to, upon compression, actuate the flow of liquid from the filling tap into the container.

Preferably, the engagement between the dimple and the at least one spigot compresses the spring member to actuate the flow of liquid from the filling tap.

Preferably, the cavity is adapted to receive only a container of predetermined size, shape and orientation.

Preferably, the size and shape of the cavity prevents the entry of the container beyond a predetermined point, thereby preventing contact between the opening of the container and the filling tap.

Preferably, the dispensing unit comprises a dispensing module that is substantially transparent to allow visual inspection of the container when the container is within the cavity.

Preferably, the dispensing unit comprises an automated measuring device to, upon actuation, accurately dispense a predetermined volume of liquid from the filling tap into the container.

Preferably, the system is gravity fed.

Preferably, the level of liquid within the dispensing unit is maintained above the level of the filling tap to facilitate dispensing of substantially entire amount of liquid contained within a dispensing unit.

Preferably, the dispensing unit is refillable.

In another embodiment of the present invention, said refillable drink container is manufactured from two separate pieces being an overcap and a body.

Preferably in this other embodiment said overcap and body are of different materials.

Even more preferably said overcap is polyethylene terephthalate (PET) said overcap is polypropylene (PP) and where said at least one dimple is in said overcap.

Preferably in a further embodiment, the refillable drink dispensing system comprises a vending apparatus in which the refilling of the container is facilitated by payment of an associated charge.

Preferably, the refillable drink dispensing system comprises a vending apparatus configured to also dispense refillable drink containers by payment of an associated charge.

Preferably, in another embodiment, the dispensing unit is a large tank comprising a filling tap located within a cavity and the large tank is located on the back of a vehicle.

### BRIEF DESCRIPTION OF THE DRAWINGS

Preferred embodiments of the invention will now be described, by way of example only and with reference to the accompanying drawings in which:

FIG. 1 depicts a front cross-sectional view of a refillable drink container for use with the drink dispensing system of the present invention according to a first preferred embodiment.

FIG. 2 depicts a front cross-sectional view of the refillable drink container shown in FIG. 1 and a drink dispensing unit.

FIG. 3 depicts a front cross-sectional view of the refillable drink container shown in FIG. 1 engaging with the drink dispensing unit shown in FIG. 2.

FIG. 4 depicts a front view of a refillable drink container for use with the drink dispensing unit of the present invention according to a second preferred embodiment.

FIG. 5 depicts a side view of the refillable drink container shown in FIG. 4.

FIG. 6 depicts a front perspective view of the refillable drink container shown in FIG. 4.

FIG. 7 depicts a rear perspective view of the refillable drink container shown in FIG. 4.

FIG. 8 depicts a top view of the refillable drink container shown in FIG. 4.

FIG. 9 depicts a perspective view of the refillable drink container shown in FIG. 4 and a drink dispensing unit.

### BEST MODE OF CARRYING OUT INVENTION

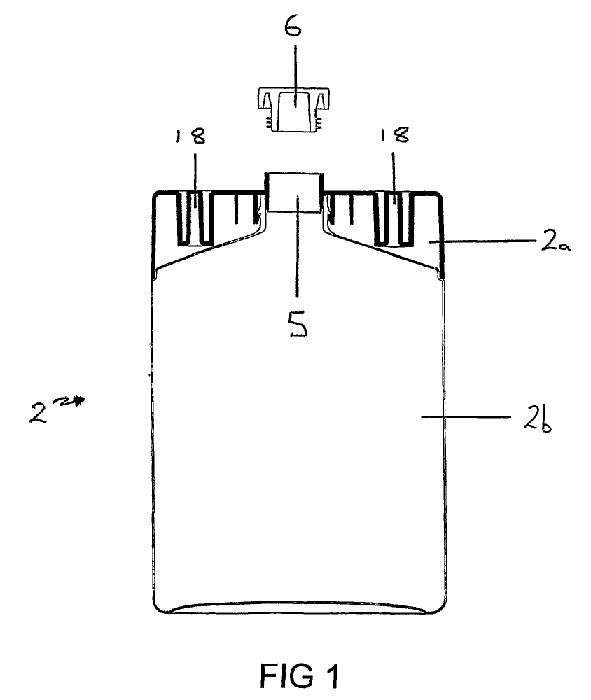

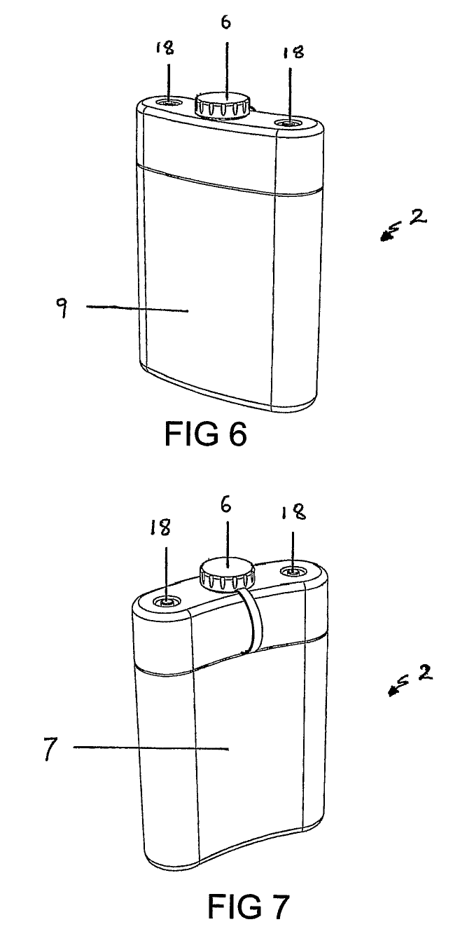

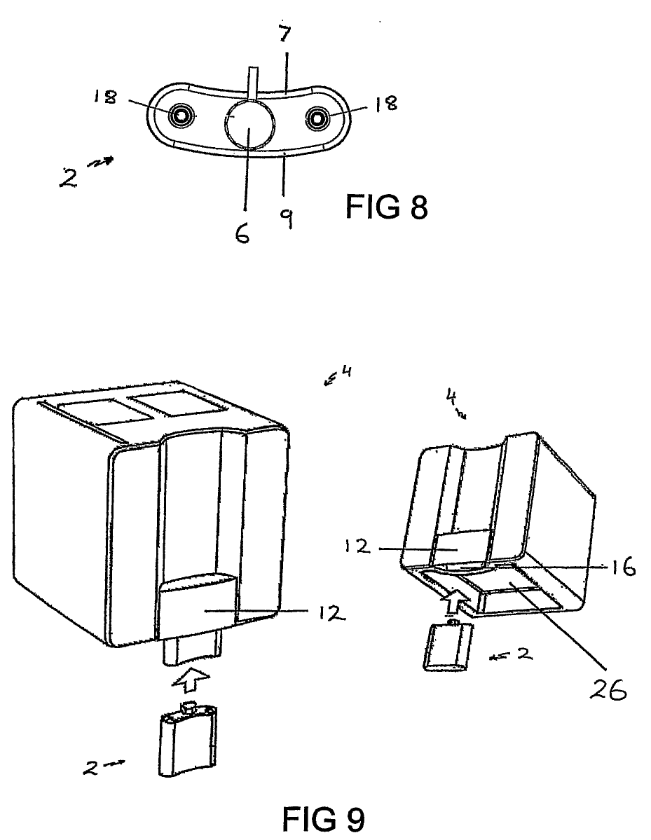

FIGS. 1 to 3 and FIGS. 4 to 9 respectively depict first and second embodiments of a drink dispensing system according to the present invention. Like reference numerals will be used to identify like features of the first and second embodiments

Generally, the present invention relates to a drink dispensing system having a refillable container and a drink dispensing unit. The refillable container is adapted to engage with said drink dispensing unit and said drink dispensing unit is adapted to hygienically dispense fluid into said refillable container.

FIGS. 1 to 3 depict a refillable drink container 2 according to a first embodiment of the present invention. The refillable container 2 comprises the conventional features of a mouth 5 adapted to allow the passage of liquid therethrough and a removable cap 6 disposed thereon.

The refillable container 2 further comprises a key element 18 in the form of two dimples located on the shoulder portion adjacent to the mouth 5. The removable cap 6 works in a conventional manner whereby the mouth 5 comprises a threaded portion onto which the removable cap 6 may be threadably engaged. Removable cap 6 is rotated about its vertical axis in order to be removed.

The refillable container 2 is manufactured from two separate pieces that are adapted to connect together. The two separate pieces are different materials, preferably having different qualities. In the embodiment shown in FIGS. 1 to 3, the refillable container 2 comprises two separate pieces 2a and 2b respectively. The lower portion 2b is manufactured from polyethylene terephthalate (PET) having a polypropylene (PP) overcap 2a from which the key elements 18 are substantially manufactured.

A relatively rigid, high strength plastic such as PP is necessary for the key elements 18 so that the engagement with the release valve 20 is sufficient to instigate liquid 30 to flow from the filling tap 22 when the refillable container 2 is inserted into the cavity 16 to engage with the spigots 20. However, a cheaper, softer plastic such as PET may be used to manufacture the rest of the bottle, other than the key elements 18. Of course, it should be understood that other suitable plastics and materials may be utilised for manufacturing the refillable container 2.

A first advantage of using this two-piece construction is that a cheaper plastic such as PET may be used for a majority of the container 2, thus lowering production and manufacturing costs, whilst the more expensive plastics, such as PP, are only used in those areas where it is essential to use rigid plastic such as the key elements 18.

A further advantage of manufacturing the refillable container 2 from two separate pieces is that each piece may be a separate colour. The two colours may be of an aesthetically pleasing combination to assist in the marketability of the refillable container 2 and/or may be used for corporate promotions, for example the refillable container 2 may have the same colours as a corporate logo or the like. The refillable container 2 may also be representative of sporting teams colours when the two pieces having different colours are combined. Also, an insignia may be included on one of the separate pieces whilst the other remains “plain” and unmarked. This may reduce the overall manufacturing costs of the refillable container 2 as the “plain” piece may be mass produced.

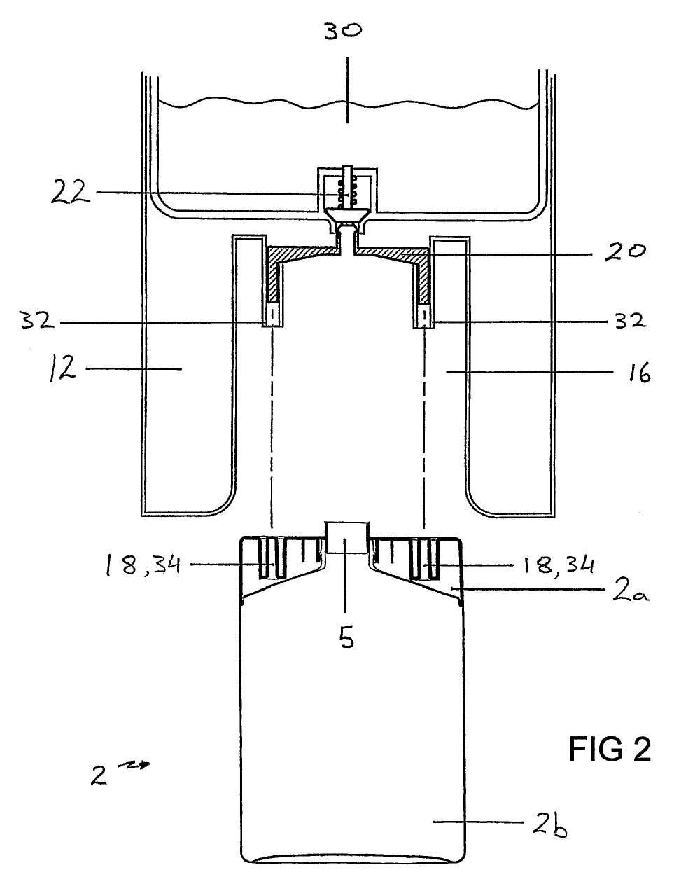

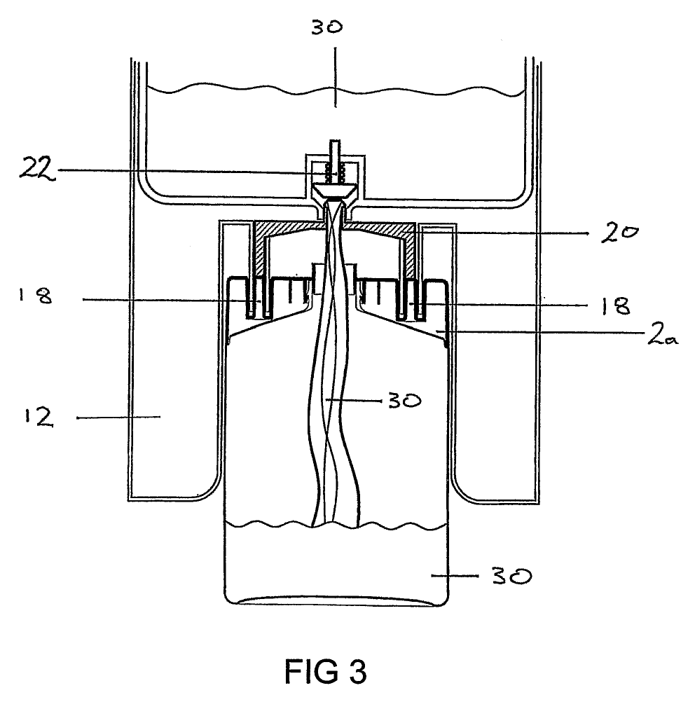

FIGS. 2 and 3 show the refillable container 2 engaging with the dispensing module 12 of filling tank 4. Dispensing module 12 includes the dispensing cavity 16 that is adapted to receive at least a portion of refillable container 2. Dispensing cavity 16 is so shaped as to exclusively receive the refillable container 2 of the drink dispensing system and not allow the entry of other differently shaped containers. Further, the predetermined specific shape of dispensing cavity 16 ensures the correct orientation of refillable container 2 within the dispensing module 12 in order that the key element 18 engages with the release valve 20 and to activate the flow of liquid 30 from the filling tap 22 into refillable container 2. Release valve 20 is preferably a spigot or actuator that projects downwardly from the filling tank 4 into the cavity 16. Key element 18 is adapted to receive a portion of the spigot or actuator therein, in order to activate the flow of liquid from the filling tap 22 of filling tank 4 into the mouth 5 of the refillable container 2.

In this preferred embodiment the release valve or spigot 20 is an actuator that comprises a watertight seal connected to a spring at the filling tap. As the refillable container 2 is pushed into the dispensing cavity 16, the spigot 20 engages with key element 18, causing the spring located at the filling tap 22 to compress and open the filling tap 22 and thus allow the liquid 30 to flow from the filling tap 22 into the refillable container 2. As the key element 18 engages with the release valve 20, the flow of liquid can either immediately be actuated upon the application of pressure upon the spring or there may be some ‘give’ in the spring whereby compression of the spring begins without actuation of the flow of liquid from the filling tap 22.

The shape of dispensing cavity 16 allows only a predetermined length of refillable container 2 to enter so that when the refillable container 2 is pushed into cavity 16, the key element 18 engages with the spigot or actuator 20 such that the mouth 5 is closely adjacent to but does not contact the filling tap 22. This ensures that the drink dispensing system of the present invention provides substantially aseptic conditions so that the refillable container 2 can be hygienically filled from filling tank 4. The contact can also be prevented by a spigot 20 of specific length having an abutment surface 32 abuts against the contact surface 34 of key element 18 and prevent any further advancement of the refillable container 2 within the cavity 16. In fact, any protrusion of the filling tank 4 can be used to abut against a corresponding abutment surface of the refillable container 2, or vice versa.

The predetermined shape of cavity 16 and the refillable container 2 assists in guiding the refillable container 2 into the cavity 16 so that it is not possible to touch the filing tap 22 with the mouth 5 of the refillable container 2. The predetermined shape of the cavity 16 is such that even if the refillable container 2 is inserted into the cavity 16 in an incorrect orientation, the refillable container 2 will not touch the filling tape 22 of the filing tank 4.

The filling tap 22 is located relatively deep within the dispensing cavity 16 in order that objects such as fingers, pens and the like cannot be inserted within the dispensing cavity 16 and contact with the filling tap 22. Dispensing cavity 16 therefore must be sufficiently narrow to minimise the likelihood of people contaminating the water supply in the filling tank 4 by touching the filling tap 22 with their fingers or other objects.

In order that the refillable container 2 does not overflow when being filled with liquid 30, dispensing module 12 may be transparent so that the user can see the liquid level in the refillable container 2 and shut the release valve 20 accordingly when the container 2 is filled with liquid 30.

Since the container system of the present invention is gravity fed, the filling tank 4 has a second cavity 26 located at the bottom surface. This cavity 26 prevents a large volume of liquid 30 to remain inaccessible in the filling tank 4. The cavity 26 raises the internal bottom surface of the filling tank 4 above the level of the filling tap 22 so that the liquid 30 does not pool below the level of the filling tap 22.

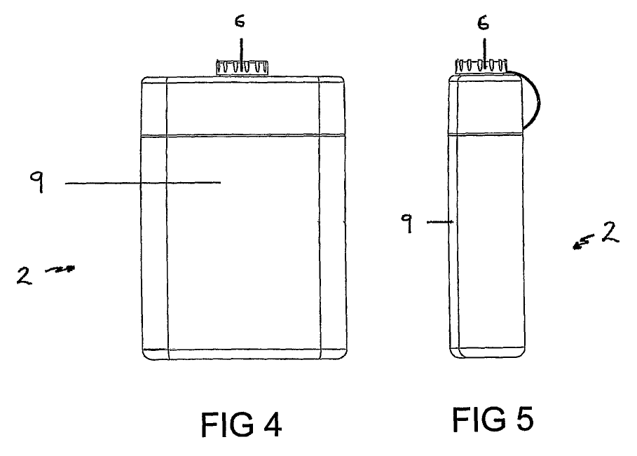

In a second embodiment shown in FIGS. 4 to 9, the refillable container 2 is contoured to substantially follow the curvature of the human body, much in the same way as conventional ‘hip flasks’. Refillable container 2 has a first substantially concave face 7 and a second substantially convex face 9. Concave face 7 contours to the shape of the body so that the refillable container 2 can be comfortably placed in a users pocket.

The refillable container 2 shown in FIGS. 4 to 9 may be made in either a two piece construction, in a similar manner to the refillable container 2 shown in FIGS. 1 to 3 or the refillable container 2 shown in FIGS. 4 to 9 may be made in a single piece construction. Where the refillable container 2 is made in a single piece construction, the type of plastic or other suitable material used to manufacture the refillable container 2 must be of sufficient rigidity that key elements 18 have sufficient strength such that when the key elements 18 are engaged with release valve 20 it is sufficient to instigate liquid 30 to flow from filling tap 22 when the refillable container 2 is inserted into the cavity 16 to engage with the spigots 20.

In a not shown further embodiment, the filling tank 4 may comprise a vending system. This vending system may accept coins, currency notes, credit cards or may charge the users mobile phone account or the like. This vending system may also be linked to a redemption system wherein points or the like are redeemed each time the refillable drink container system is used.

Additionally, the refillable container 2 may include a bar code or the like that is scanned by the filling tank 4 each time the refillable container 2 is filled with liquid 30. In this case, the refillable container 2 may be used with the filling tank a set number of times before the ‘credit’ on the account expires. In a further embodiment not shown in the Figures, the vending system may, when activated by means described above, dispense a refillable container 2 for use with the filling tank 4.

Whilst the abovementioned embodiments refer to water dispensing systems, it should be understood that in other not shown embodiments the dispensing system may be used with other forms of drinks such as cordials, sports and energy replenishing drinks, flavoured milk, alcoholic beverages or the like.

It should be understood that the filling tank 4 may be refilled once the supply of liquid 30 within the tank is exhausted.

It must be understood that whilst in the embodiment shown in FIGS. 4 to 9, the second face 9 of the refillable container 2 is substantially convex, in other not shown embodiments second face 9 may be substantially planar or concave. In other not shown embodiments, the refillable container 2 may be of conventional cylindrical design.

It must be understood that in other not shown embodiments cap 6 may be engaged with the refillable container 2 by frictional engagement wherein the cap 6 is ‘pushed’ into a closed position on the container 2 and ‘pulled off’ in order to expose mouth 5.

Whilst in both the abovementioned embodiments the key element 18 is in the form of two dimples, it should be understood that in other not shown embodiments any number of dimples, including a single dimple may be used. It should also be understood that the key element 18 of the abovementioned embodiments may, in other not shown embodiments, have a shape and form different to the dimples shown. Also, whilst both of the abovementioned embodiments show only one spigot 22, it should be understood that multiple spigots may be disposed on the filling tank 4 and are adapted for engagement with the refillable container 2.

In an embodiment not shown in the Figures, the release valve 20 may comprise a ‘female engagement portion’ adapted to engage with a ‘male engagement portion’ disposed on the refillable container 2. In this case, the refillable container comprises the spigot portion and the release valve 20 may be engageable with the spigot portion of the refillable container. In another not shown embodiment, the spigot portion of the filling tank 4 may be adapted to engage with a portion of the refillable container 2 other than the key elements 18. For example, a section of the exterior surface of the shoulder or other portion of the refillable container 2 may be substantially flat in order to engage with the spigot 20 or other protrusion of the filling tank 4.

In other not shown embodiments, the shape of the refillable container 2 is such that a first portion is shaped to fit within dispensing cavity 16 and, as the refillable container 2 is pushed further within the cavity 16, a lower portion of the container 2 will engage with the lower edge of cavity 16 to prevent any further entrance of refillable container 2 into dispensing cavity 16.

In a further not shown embodiment the filling tank 4 may further comprise a measuring device that dispenses a set amount of liquid 30 into the refillable container 2. For example, if the container 2 is 350 mL, the filling tank 4 will dispense a predetermined amount of 350 mL each time the release valve 20 is actuated. In this embodiment the refillable container 2 must be completely drained of liquid 30 to avoid overflow when refilling the container 2 from tank 4.

It should be understood that throughout the description reference to the word “drink” includes liquid that may be used for drinking but also includes other uses such as for refreshment wherein the user splashes liquid on their face, cleaning and washing of the user's hands and the like.

Whilst the embodiments shown in the drawings refer to a portable “stand alone” filling tank 4, it should be understood that in other embodiments not shown in the drawings, the filling tank 4 may be replaced by a reservoir or large tank on the back of a truck provided with the dispensing module 12 for use with large events. Additionally, the filling tank 4 may also be connected to a permanent water supply such as town water.

The term “comprising” (and its grammatical variations) as used herein is used in the inclusive sense of “having” or “including” and not in the exclusive sense of “consisting only of”.

1. A refillable drink container system, comprising:
a drink dispensing unit with a filling tap located within a cavity; and
a refillable drink container having an opening for the passage of liquid therethrough, at least a portion of said container being adapted to enter said cavity and engage with said dispensing unit such that said opening in the container is positioned near said filling tap to allow liquid to be dispensed from said filling tap into said drink container;
wherein said engagement between said dispensing unit and said container prevents contact between said opening of said container and said filling tap.

2. The refillable drink container system of claim 1, wherein said dispensing unit has a protrusion adapted to abut against an abutment surface of said container when said container is inserted into said cavity.

3. The refillable drink container system of claim 1, wherein the engagement between said dispensing unit and said container is, at least partially, provided by respective male and female members associated with said dispensing unit and said container.

4. The refillable drink container system of claim 3, wherein said male member is located on said dispensing unit and said female member is located on said container.

5. The refillable drink container system of claim 3, wherein said female member is located on said dispensing unit and said male member is located on said container.

6. The refillable drink container system of claim 3, wherein:
said dispensing unit comprises at least one spigot;
an external surface of said container comprises at least one key element adapted to engage said dispensing unit by receiving a portion of said at least one spigot therein; and
said key element provides an abutment surface for said spigot to prevent further insertion of said container into said cavity, thereby one of said at least one spigots prevents contact between said opening of said container and said filling tap.

7. The refillable drink container system of claim 6, wherein said key element is connected to an actuator, said actuator in connection with said filling tap and adapted to initiate the flow of liquid from said filling tap upon actuation when said container is engaged with said dispensing unit.

8. The refillable drink container system of claim 6, wherein said key element is a dimple.

9. The refillable drink container system of claim 6, wherein said at least spigot comprises a spring member arranged to, upon compression, actuate the flow of liquid from said filling tap into said container.

10. The refillable drink container system of claim 6, wherein the engagement between said key element and said at least one spigot compresses said spring member to actuate the flow of liquid from said filling tap.

11. The refillable drink container system of claim 1, wherein said cavity is adapted to receive only a container of predetermined size, shape and orientation.

12. The refillable drink container system of claim 11, wherein the size and shape of said cavity prevents the entry of said container beyond a predetermined point, thereby preventing contact between said opening of the container and said filling tap.

13. The refillable drink container system of claim 1, having a substantially transparent dispensing module to allow visual inspection of said container when said container is within said cavity.

14. The refillable drink container system of claim 1, wherein said dispensing unit comprises an automated measuring device to, upon actuation, accurately dispense a predetermined volume of liquid from said filling tap into said container.

15. The refillable drink container system of claim 1, wherein said system is gravity fed.

16. The refillable drink container system of claim 15, wherein the level of liquid within said dispensing unit is maintained above the level of said filling tap to facilitate dispensing of substantially entire amount of liquid contained within a dispensing unit.

17. The refillable drink container system of any claim 1, wherein said dispensing unit is refillable.

18. The refillable drink container system of claim 6, wherein said refillable drink container is manufactured from a first piece and a second piece separate from the first piece, the first piece being an overcap and the second piece being a body.

19. The refillable drink container system of claim 18, wherein said overcap and said body are of different materials.

20. The refillable drink container system of claim 19, wherein said overcap is polyethylene terephthalate (PET), said overcap is polypropylene (PP), and where wherein said at least one dimple is in said overcap.

21. The refillable drink container system of claim 1, wherein said dispensing unit is a large tank comprising a filling tap located within a cavity and said large tank is located on the back of a vehicle.

22. A vending apparatus comprising a liquid dispensing unit according to claim 1.

23. A vending apparatus comprising the refillable drink system according to claim 22, wherein said vending apparatus is configured to also dispense refillable drink containers.
